(19) United States
(12) Patent Application Publication
(10) Pub. No.: US 2025/0118998 A1
(43) Pub. Date: Apr. 10, 2025

(54) COMMUNICATION FOR WIRELESS CHARGING

(71) Applicant: Google LLC, Mountain View, CA (US)

(72) Inventors: Zhenxue Xu, Mountain View, CA (US); Shuo Wang, Gainesville, FL (US); Liang Jia, Palo Alto, CA (US); Srikanth Lakshmikanthan, Milpitas, CA (US); Yirui Yang, Mountain View, CA (US)

(21) Appl. No.: 18/909,702

(22) Filed: Oct. 8, 2024

Related U.S. Application Data
(60) Provisional application No. 63/588,861, filed on Oct. 9, 2023.

(51) Int. Cl. H02J 50/80; H02J 50/12

(52) U.S. Cl. CPC H02J 50/80; H02J 50/12; H02J 2207/20

(57) ABSTRACT

An electronic device includes a wireless charging receive coil configured to transduce, into an alternating current (AC) power signal, a magnetic field generated by a wireless charging transmit coil of an external device; an active rectifier configured to convert the AC signal received at an AC side of the active rectifier into a direct current (DC) power signal output at a DC side of the active rectifier, the active rectifier comprising a plurality of switches; a first modulation capacitor connected to an upper rail of the AC side; a second modulation capacitor connected to a lower rail of the AC side; and a controller configured to adjust an impedance of the computing device to communicate with the external device by at least controlling the plurality of switches to cause the first modulation capacitor and the second modulation capacitor to charge during separate time periods.

This application claims the benefit of U.S. Provisional Patent Application No. 63/588,861, filed 9 Oct. 2023, the entire contents of which is incorporated herein by reference.

### BACKGROUND

Computing devices, such as smartphones, laptops, wearable devices, and tablets, may include wireless charging capabilities. Computing devices may operate as wireless charging source devices that wirelessly provide power or wireless charging sink devices that wirelessly receive power. For instance, a wireless charging sink device may include a receiver coil and other components capable of transducing a magnetic field into an electrical power signal that may be used to charge a battery of the computing device or otherwise operate components of the computing device. Similarly, a wireless charging source device may include a power supply that outputs a signal to a transmitter coil that causes the transmitter coil to generate a magnetic field. A controller of the wireless charging source device may adjust operation of the power supply to control an amount of power provided and/or properties of the electrical power signal at the wireless charging receive device.

### SUMMARY

In general, this disclosure is directed to a wireless charging sink device that utilizes an active rectifier to improve communication of the wireless power transfer channel. During transfer of power from a wireless charging source device (hereinafter, a source device) to a wireless charging sink device (hereinafter, a sink device), it may be desirable for the sink device to communicate with the source device. In some examples, the sink device may communicate with the sink device by modulating its impedance (e.g., to communicate via amplitude shift keying (ASK)). For instance, the sink device may include modulation capacitors that are switched in and out to perform the impedance modulation. The depth of modulation may be a function of a capacitance of the modulation capacitors. Larger capacitors may provide increased modulation depth. However, it may not be desirable to increase the capacitance. For instance, chargers with greater capacitance may be larger and/or more costly.

In accordance with one or more aspects of this disclosure, a controller of the sink device may utilize switches of an active rectifier of the sink device to increase the effective capacitance of the modulation capacitors. For instance, the controller may use the switches to cause the modulation capacitor to charge separately (e.g., during separate time periods) as opposed to simultaneously. As such, only one of the modulation capacitors may be in parallel with an input capacitor of the sink device at a given time. Such a scheme may effectively double a modulation depth of the sink device. In this way, the controller may improve a performance of sink device to source device communication.

In one example, a device includes a wireless charging receive coil configured to transduce, into an alternating current (AC) power signal, a magnetic field generated by a wireless charging transmit coil of an external device; an active rectifier configured to convert the AC signal received at an AC side of the active rectifier into a direct current (DC) power signal output at a DC side of the active rectifier, the active rectifier comprising a plurality of switches; a first modulation capacitor connected to an upper rail of the AC side; a second modulation capacitor connected to a lower rail of the AC side; and a controller configured to adjust an impedance of the computing device to communicate with the external device by at least controlling the plurality of switches to cause the first modulation capacitor and the second modulation capacitor to charge during separate time periods.

In another example, a method includes transducing, by a wireless charging receive coil of an electronic device, into an AC power signal, a magnetic field generated by a wireless charging transmit coil of an external device; converting, by an active rectifier of the electronic device, the AC signal received at an AC side of the active rectifier into a DC power signal output at a DC side of the active rectifier, the active rectifier comprising a plurality of switches; and communicating, by a controller of the electronic device, with an external device by at least adjusting an impedance of the electronic device including controlling the plurality of switches to cause a first modulation capacitor and a second modulation capacitor to charge during separate time periods, the first modulation capacitor connected to an upper rail of the AC side and the second modulation capacitor connected to a lower rail of the AC side.

In another example, a computer-readable storage medium stores instructions that, when executed by a controller of an electronic device, cause the controller to control switches of an active rectifier of the electronic device to communicate with an external device by at least causing a first modulation capacitor and a second modulation capacitor to charge during separate time periods, the first modulation capacitor connected to an upper rail of an AC side of the active rectifier and the second modulation capacitor connected to a lower rail of the AC side.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1 is a block diagram illustrating a system that includes a wireless charging source device and a wireless charging sink device that includes an active rectifier configured to perform power regulation, in accordance with one or more aspects of this disclosure.

FIG. 2 is a schematic diagram illustrating an example sink device, in accordance with one or more aspects of this disclosure.

FIGS. 3A-3D are copies of the schematic of FIG. 2, with dashed lines illustrating current flows during various time periods of operation, in accordance with one or more aspects of this disclosure.

FIG. 4 is a graph illustrating example voltage and current levels over the time periods described in FIGS. 3A-3D, in accordance with one or more aspects of this disclosure.

FIGS. 5A-5I are copies of the schematic of FIG. 2, with dashed lines illustrating current flows during various time periods of operation, in accordance with one or more aspects of this disclosure.

FIG. 6 is a graph illustrating example voltage and current levels over the time periods described in FIGS. 5A-5I, in accordance with one or more aspects of this disclosure.

FIG. 7 is a flowchart illustrating an example technique for communicating over a wireless power link, in accordance with one or more aspects of this disclosure.

FIG. 8 is a graph illustrating example communication between a sink device and a source device, in accordance with one or more aspects of this disclosure.

### DETAILED DESCRIPTION

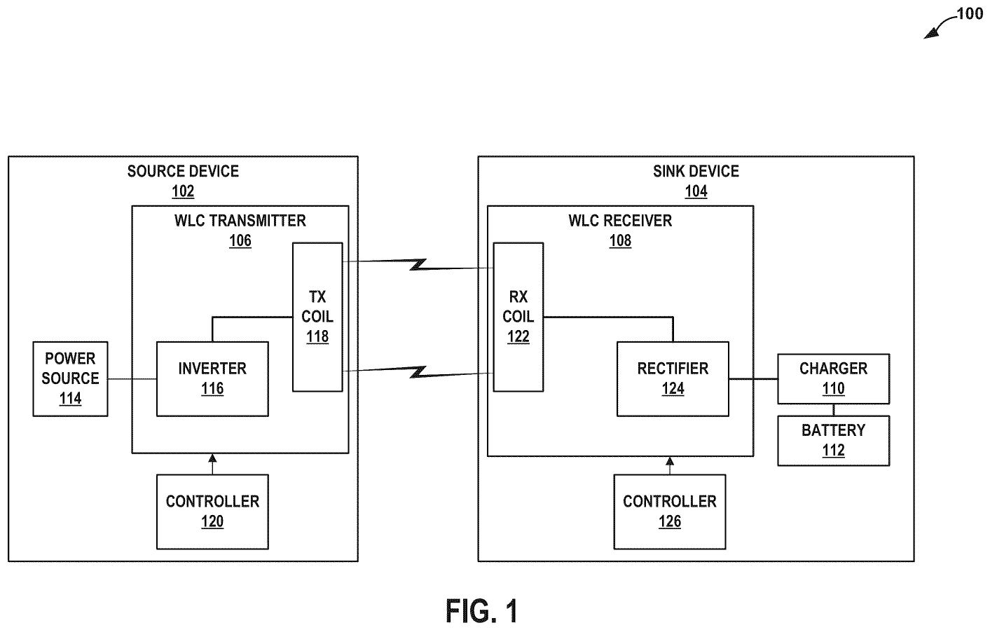

FIG. 1 is a block diagram illustrating a system that includes a wireless charging source device and a wireless charging sink device that includes an active rectifier configured to assist in amplitude shift keying modulation, in accordance with one or more aspects of this disclosure. As shown in FIG. 1, system 100 may include wireless charging source device 102 (“source device 102”) and wireless charging sink device 104 (“sink device 104”).

Source device 102 may be any type of device that wirelessly provides power to another device. Examples of source device 102 include, but are not limited to, a charging pad, an alarm clock, a power bank, a mobile phone, a camera device, a tablet computer, a smart display, a laptop computer, a desktop computer, a gaming system, a media player, an e-book reader, a television platform, a vehicle infotainment system or head unit, a vehicle surface with integrated charging, or a wearable computing device (e.g., a computerized watch, a head mounted device such as a VR/AR headset, computerized eyewear, a computerized glove). As shown in FIG. 1, source device 102 may include wireless charging (WLC) transmitter 106 and power source 114.

Power source 114 may be any component capable of providing electrical power to other components of source device 102. Examples of power source 114 include, but are not limited to, batteries, solar panels, wall adapters, wireless charging receive coils, etc. As shown in FIG. 1, power source 114 may provide electrical power (e.g., direct current (DC) electrical power) to WLC transmitter 106.

WLC transmitter 106 may be configured to wirelessly provide power to another device. In some examples, WLC transmitter 106 may be compliant with (e.g., operate in accordance with) a wireless charging standard such as the Qi specification published by the Wireless Power Consortium (e.g., available at wirelesspowerconsortium.com/knowledge-base/specifications/download-the-qi-specifications.html). As shown in FIG. 1, WLC transmitter 106 may include inverter 116, transmitter (Tx) coil 118, and controller 120.

Inverter 116 may be configured to convert a direct current (DC) signal into an alternating current (AC) signal. For instance, inverter 116 may convert a DC power signal received from power source 114 into an AC power signal, and provide the AC power signal to Tx coil 118. As discussed in further detail below, in some examples, inverter 116 may be an active full bridge inverter that includes a plurality of switches. Operation of the plurality of switches may be controlled by a controller, such as controller 120.

Controller 120 may be configured to control operation of one or more components of WLC transmitter 106. For instance, controller 120 may include circuitry configured to control operation of inverter 116. As one example, the circuitry of controller 120 may adjust one or more of a voltage level of the DC signal provided to inverter 116, a switching frequency of switches of inverter 116, and/or a duty cycle of the switches of inverter 116. Examples of controller 120 include, but are not limited to, one or more digital signal processors (DSPs), general purpose microprocessors, application specific integrated circuits (ASICs), field programmable logic arrays (FPGAs), systems on a chip (SoC), or other equivalent integrated or discrete logic circuitry, or analog circuitry.

Tx coil 118 may be configured to generate a magnetic field proportional to a power signal flowing through Tx coil 118. For instance, Tx coil 118 may generate a magnetic field having properties proportional to the AC power signal output to Tx coil 118 from inverter 116.

Sink device 104 may be any type of device that operates at least in part using power wirelessly received from another device. Examples of sink device 104 include, but are not limited to, a power bank, a mobile phone, a camera device, a tablet computer, a smart display, a laptop computer, a desktop computer, a gaming system, a media player, an e-book reader, a television platform, or a wearable computing device. As shown in FIG. 1, sink device 104 may include wireless charging (WLC) receiver 108, charger 110, and battery 112.

WLC receiver 108 may be configured to wirelessly receive power from another device. In some examples, WLC receiver 108 may be compliant with (e.g., operate in accordance with) a wireless charging standard such as the Qi specification published by the Wireless Power Consortium (e.g., available at wirelesspowerconsortium.com/knowledge-base/specifications/download-the-qi-specifications.html). As shown in FIG. 1, WLC receiver 108 may include receiver (Rx) coil 122, rectifier 124, and controller 126.

Rx coil 122 may be configured to transduce a magnetic field into a power signal. For instance, Rx coil 122 may transduce the magnetic field generated by Tx coil 118 into an AC power signal having properties proportional to the magnetic field (e.g., and thus proportional to AC power signal output to Tx coil 118 from inverter 116). Rx coil 122 may output the transduced AC power signal to one or more components of WLC receiver 108, such as rectifier 124.

Rectifier 124 may be configured to convert an AC signal into a DC signal. For instance, rectifier 124 may convert an AC power signal received from Rx coil 122 into a DC power signal, and provide the DC power signal to another component of sink device 104, such as charger 110. As discussed in further detail below, in some examples, rectifier 124 may be an active full bridge rectifier that includes a plurality of switches. In this sense, rectifier 124 may be considered to be an active rectifier (e.g., as opposed to a bridge formed entirely of passive diodes). Operation of the plurality of switches may be controlled by a controller, such as controller 126.

Controller 126 may be configured to control operation of one or more components of WLC receiver 108. For instance, controller 126 may include circuitry configured to control operation of rectifier 124. As one example, the circuitry of controller 126 may adjust one or more of a switching frequency of switches of rectifier 124, and/or a duty cycle of the switches of rectifier 124. Examples of controller 126 include, but are not limited to, one or more digital signal processors (DSPs), general purpose microprocessors, application specific integrated circuits (ASICs), field programmable logic arrays (FPGAs), systems on a chip (SoC), or other equivalent integrated or discrete logic circuitry, or analog circuitry.

Components of sink device 104 may utilize the DC power signal output by WLC receiver 108 to perform various operations. For instance, charger 110 may utilize the DC power signal output by WLC receiver 108 to charge battery 112.

Reliable communication between sink device 104 and source device 102 may be beneficial to the reliability of the power transfer process. Source device 102 and/or sink device 104 may utilize communication to determine interoperability, exchange charging data, and other operations.

As noted above, sink device 104 and source device 102 may be compliant with one or more wireless charging standards, such as the Qi standard. The Qi standard includes communication protocols to improve safety and efficiency of the charging process. For example, the Qi standard prescribes performance of Foreign Object Detection (FOD), which detects if any foreign objects are on the charging pad or mat, and Dynamic Power Control (DPC), which adjusts the power output to match the device's charging needs. Due to these (e.g., FOD and/or DPC) and/or other reasons, source device 102 may terminate the charging process responsive to a failure of communication with sink device 104. As such, it may be desirable for communication between source device 102 and sink device 104 to be robust and reliable. The Qi standard adopts an in-band communication technique for the aforementioned communication between source device 102 and sink device 104.

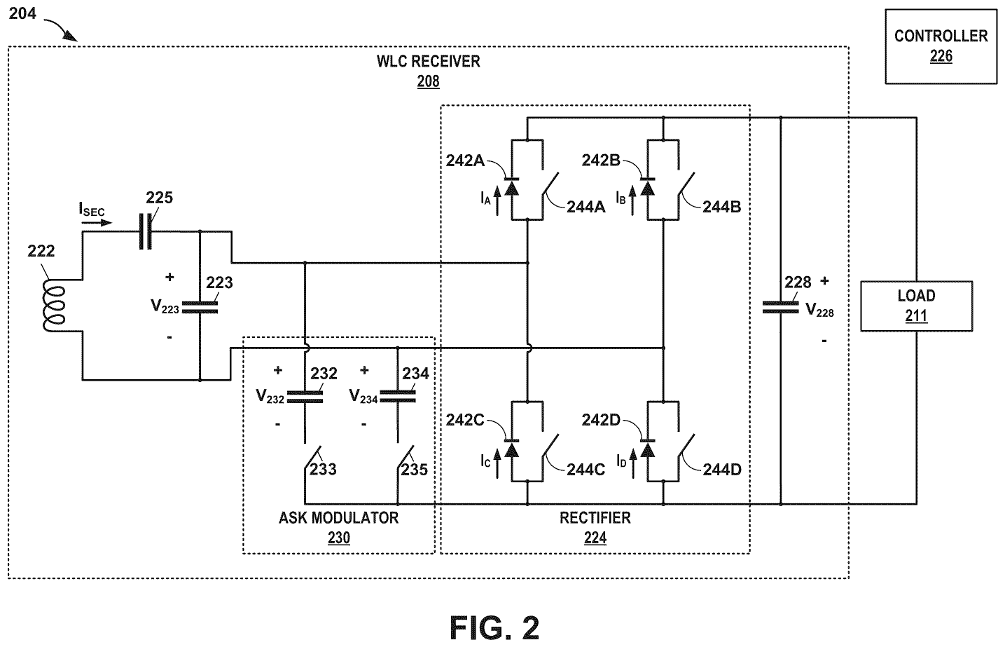

In utilizing the in-band communication technique of Qi, source device 102 and sink device 104 may utilize the wireless power transfer channel to convey data. For the Tx-Rx (source device 102 to sink device 104) communication, source device 102 may modulate the data by switching its operating frequency. Controller 126 of sink device 104 may detect this frequency difference and interpret it as digital signal 1s and 0s. Thus, data can be transferred from source device 102 to sink device 104. For the Rx-Tx (sink device 104 to source device 102) communication, sink device 104 may modulate its impedance (e.g., selectively coupling, to its DC ground, modulation capacitors C_{mod} from both sides of Rx coil 122, such as capacitors 232 and 234 of FIG. 2A), resulting in a current amplitude variation at source device 102. Controller 120 of source device 102 may detect this variation and interpret it as digital signals as well. Thus, data can be transferred from sink device 104 to source device 102.

Both Tx-Rx and Rx-Tx communication may use a shift-keying scheme to modulate digital bits with frequency variations or amplitude variations. The Tx-Rx communication modulates the operating frequency, thus named as Frequency Shift Keying (FSK). And the Rx-Tx communication is named Amplitude Shift Keying (ASK) because it modulates the amplitude of waveforms.

Compared with FSK, ASK may be much more susceptible to noises and may be more likely to fail because its data signal may be more likely to be corrupted by load variations or noises. It is a systematic disadvantage of ASK. Therefore, improving the reliability of ASK may be desirable in improving the reliability of in-band communications.

In high-noise conditions, ASK modulation may suffer from a reduced signal-to-noise ratio (SNR). To combat this reduced SNR, some designs may use larger capacitance C_{mod} to increase modulation depth. However, including such larger capacitance may present one or more disadvantages, such as increased cost and/or space (e.g., board space and/or component volume).

In accordance with one or more aspects of this disclosure, sink device 104 may utilize one or more components of rectifier 124 to improve the performance of ASK modulation. For instance, as discussed in further detail below, controller 126 may controller switches in parallel with diodes of a bridge of rectifier 124 to increase a modulation depth of the ASK modulation. In this way, aspects of this disclosure may improve the reliability of in-band communications between sink device 104 and source device 102.

FIG. 2 is a schematic diagram illustrating an example sink device, in accordance with one or more aspects of this disclosure. Sink device 204 of FIG. 2 may be an example of sink device 104 of FIG. 1. As shown in FIG. 2, sink device 204 may include WLC receiver 208, load 211, and controller 226. WLC receiver 208 and controller 226 of FIG. 2 may respectively be examples of WLC receiver 108 and controller 126 of FIG. 1. Load 211 may represent a combination of charger 110 and battery 112, and/or any other electrical load of sink device 204.

As shown in FIG. 2, WLC receiver 108 may include Rx coil 222, rectifier 224, capacitor 223 (e.g., an input capacitor), capacitor 225, output capacitor 228, and ASK modulator 230. Rx coil 222 and rectifier 224 of FIG. 2 may be examples of Rx coil 122 and rectifier 124 of FIG. 1.

Rectifier 224 may include various components configured to convert an AC electrical signal into a DC electrical signal. Rectifier 224 may have an AC side on which an input AC electrical signal is received (e.g., via Rx coil 222) and a DC side on which an DC electrical signal is output (e.g., to load 211). Rectifier 224 may include a diode bridge to perform the rectification. For instance, as shown in FIG. 2, rectifier 224 may include diodes 242A-242D (collectively, “diodes 242”) in a full-bridge configuration.

As discussed above, in some examples, rectifier 224 may be an active, or a synchronous rectifier. For instance, as shown in FIG. 2, rectifier 224 may include switches 244A-244D (collectively, “switches 244”), shown as being in parallel with diodes 242. Controller 226 may control switches 244 such that rectifier 224 effectively operates as if diodes 242 are ideal diodes. For instance, responsive to current I_{A} (i.e., the current flowing through diode 242A) being greater than 0, controller 226 may cause switch 244A to close and responsive to current I_{A} being less than or equal to 0, controller 226 may cause switch 244A to open. Controller 226 may control the remainder of switches 244 in a similar manner (e.g., causing switch 244D to close responsive to current I_{D} being greater than 0 and causing switch 244D to open responsive to current I_{D} being less than or equal to 0).

ASK modulator 230 may include one or more components to perform ASK modulation. As shown in FIG. 2, ASK modulator 230 may include modulation capacitors 232 and 234, along with corresponding switches 233 and 235. Modulation capacitor 232 may be connected to a high side (e.g., an upper rail) of the AC side of rectifier 224 and modulation capacitor 234 may be connected to a low side (e.g., a lower rail) of the AC side of rectifier 224. Switches 233 and 235 may selectively couple modulation capacitors 232 and 234 to a low side (e.g., a lower rail) of a DC side of rectifier 224 (e.g., a ground of sink device 204). For instance, switch 233 may connect modulation capacitor 232 to the low side of the DC side of rectifier 224 and switch 235 may connect modulation capacitor 234 to the low side of the DC side of rectifier 224.

As discussed above, in some ASK modulation schemes, modulation capacitors, such as capacitors 232 and 234, may be selectively coupled to a DC ground to modulate an impedance of sink device 204, thereby causing a current amplitude variation at a source device (e.g., source device 102). For instance, to send a first symbol (e.g., a 1 or a 0), controller 226 may cause switches 233 and 235 to be open. Similarly, to send a second symbol (e.g., the other of 1 or 0 than the first symbol), controller 226 may cause switches 233 and 235 to close. When switches 233 and 235 are closed and capacitors 232 and 234 each have a capacitance of C_{mod}, half of the capacitance of capacitors 232 and 234 is added to the capacitance of capacitor 223 (e.g., only

$$\frac{{C}_{m o d}}{2}$$

is added to the capacitance of capacitor 223).

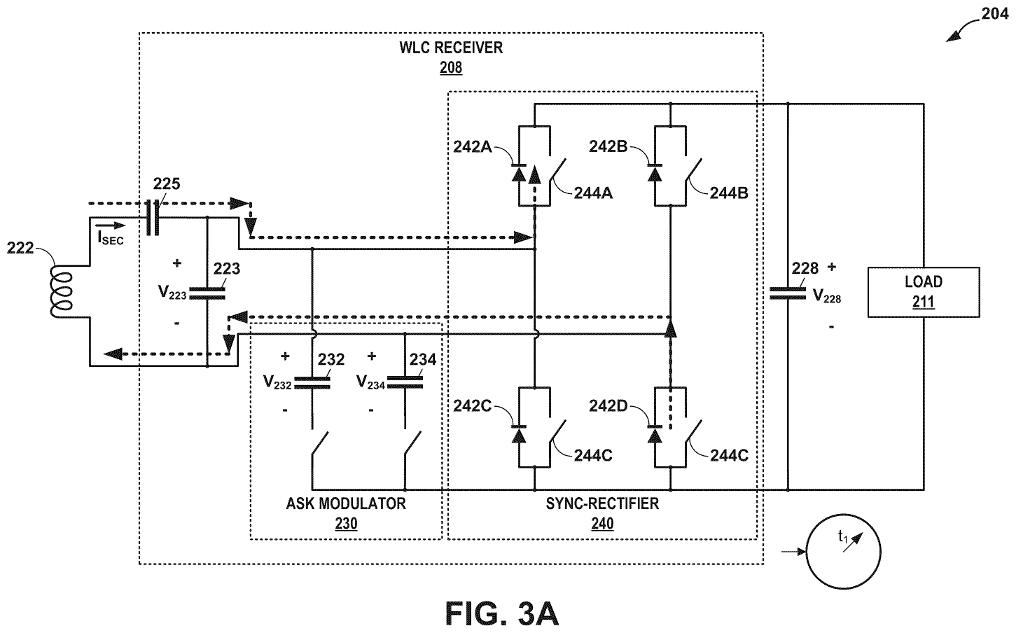

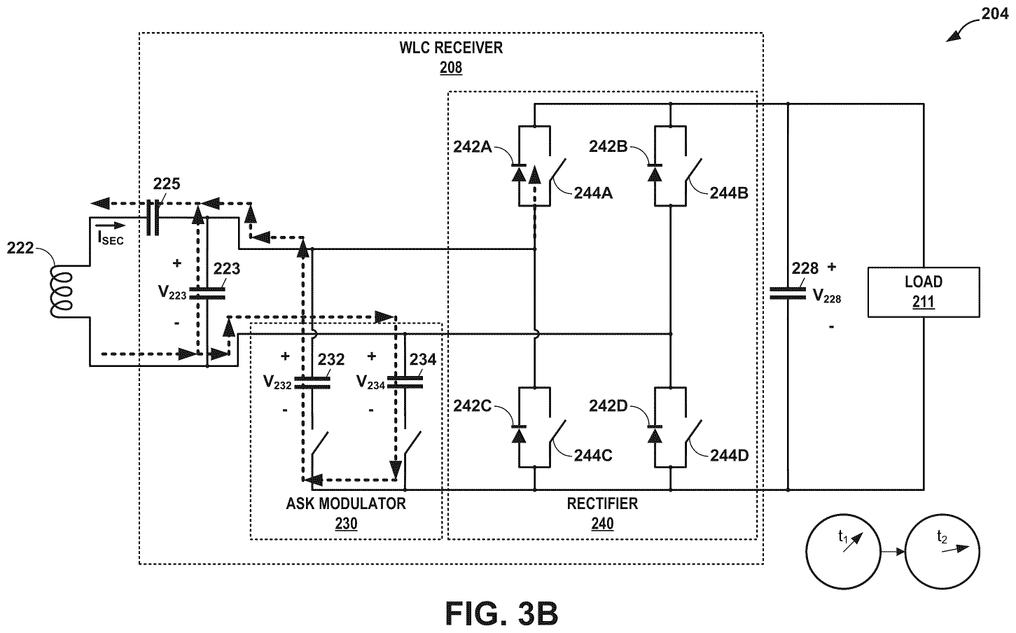

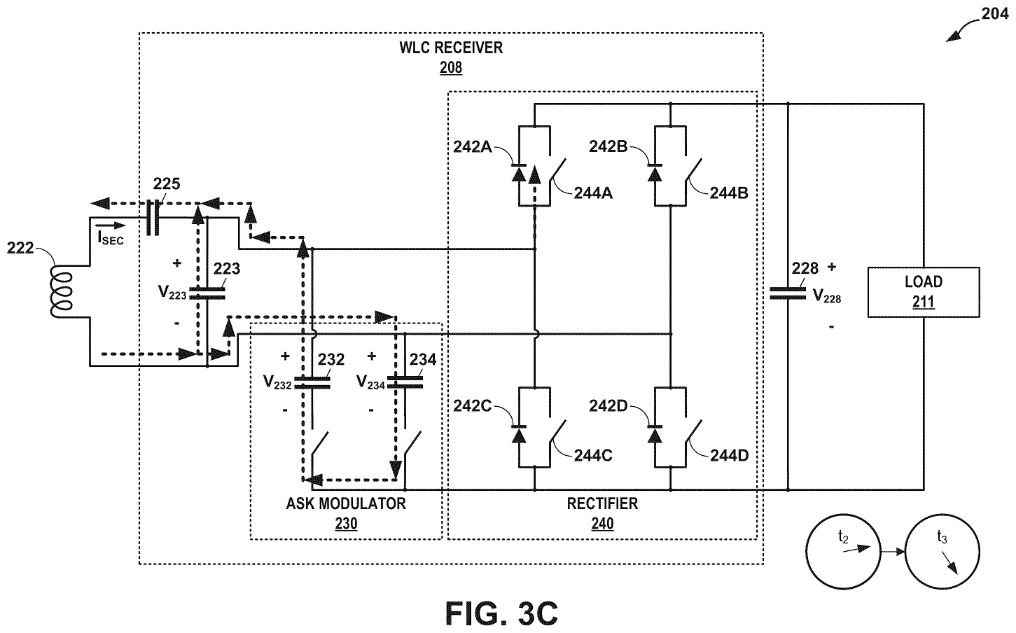

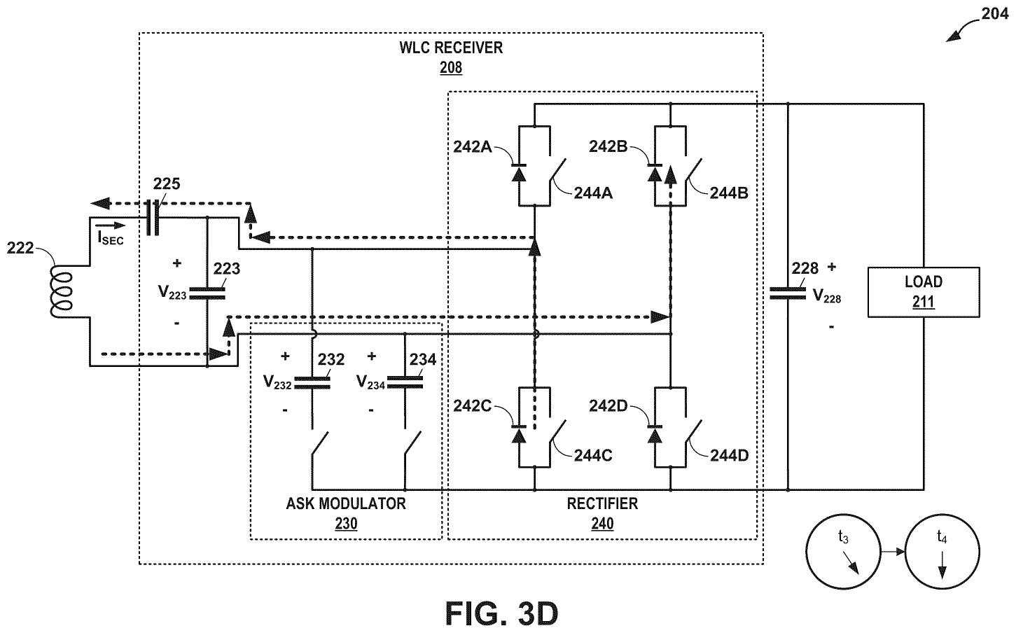

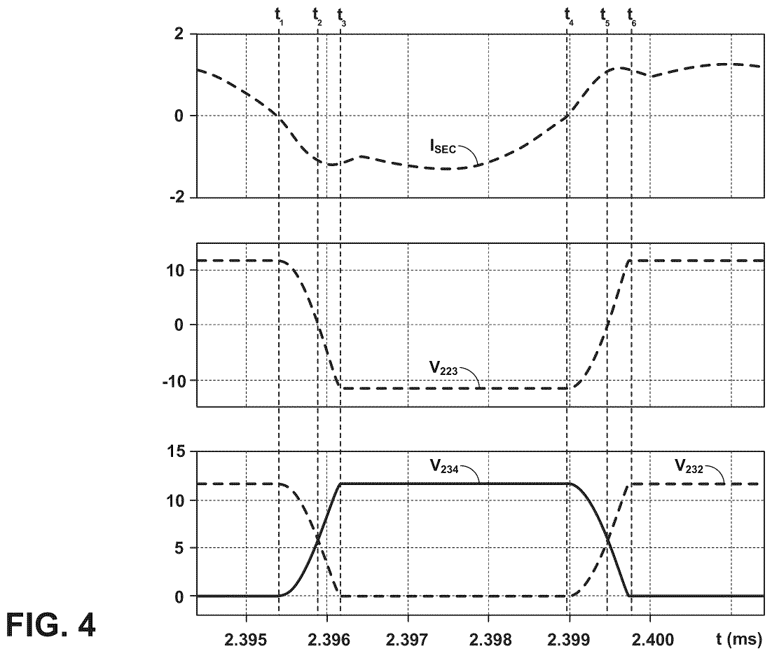

FIGS. 3A-3D are copies of the schematic of FIG. 2, with dashed lines illustrating current flows during various time periods of operation, in accordance with one or more aspects of this disclosure. FIG. 4 is a graph illustrating example voltage and current levels over the time periods described in FIGS. 3A-3D, in accordance with one or more aspects of this disclosure. The time periods shown in FIGS. 3A-3D may correspond to those shown in FIG. 4. For instance, FIG. 3A illustrates flows in a time period prior to time t₁, FIG. 3B illustrates flows in a time period between time t₁ and time t₂, FIG. 3C illustrates flows in a time period between time t₂ and time t₃, and FIG. 3D illustrates flows in a time period between time t₃ and time t₄.

The induced current in Rx coil 222, I_{SEC}, is alternating. The waveform in FIG. 4 starts at a positive I_{SEC} prior to time t₁. The modulation capacitors 232 and 234 are denoted separately, with their voltages denoted as V₂₃₂ and V₂₃₄. The voltage across capacitor 223 is denoted as V₂₂₃. At the starting moment, V₂₃₂=V₂₂₃ and V₂₃₄=0.

The transient starts when I_{SEC} changes its polarity, crossing zero at time t₁. During t₁<t<t₃, as all diodes 242 are off, capacitor 232 and capacitor 234 share the same current, as shown in FIGS. 3B and 3C, and FIG. 4. Put in other words, capacitor 232 and capacitor 234 are connected in series. Furthermore, the series of capacitor 232 and capacitor 234 is directly paralleled with Cd. As such, as discussed above, the overall effect of the two modulation capacitors 232 and 234, each with capacitance C_{mod}, is adding C_{mod}/2 to capacitor 223. This conclusion also holds in the transient from t₄ to t₆, which is very similar to what is analyzed above

In accordance with one or more aspects of this disclosure, controller 226 may utilize one or more of the components of rectifier 224 to enhance the ASK modulation used to communicate with a source device. For instance, controller 226 may adjust the control of switches of rectifier 240 to enhance the modulation depth of the ASK modulation.

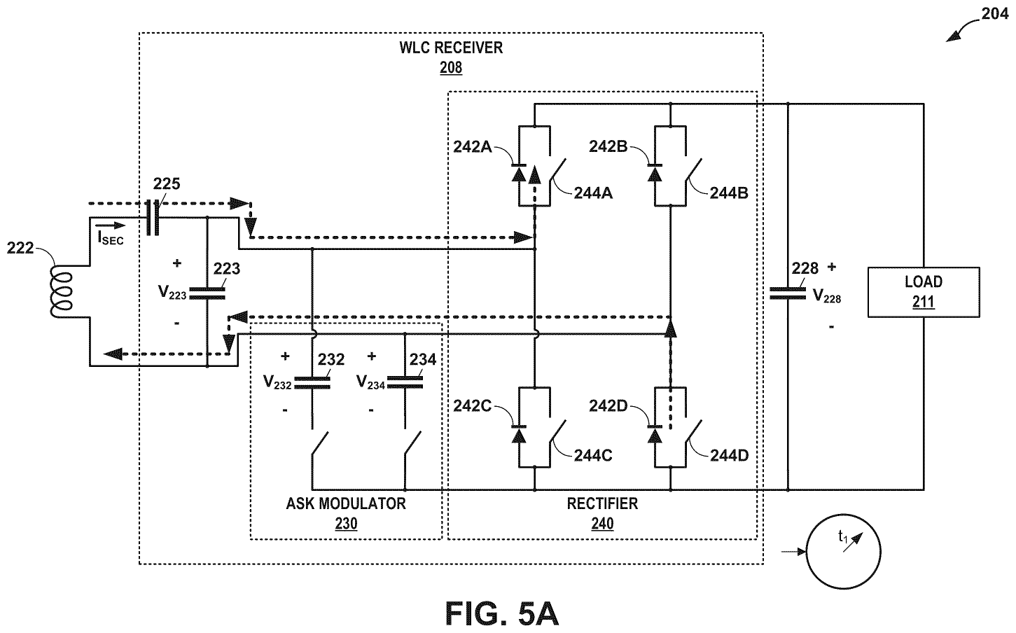

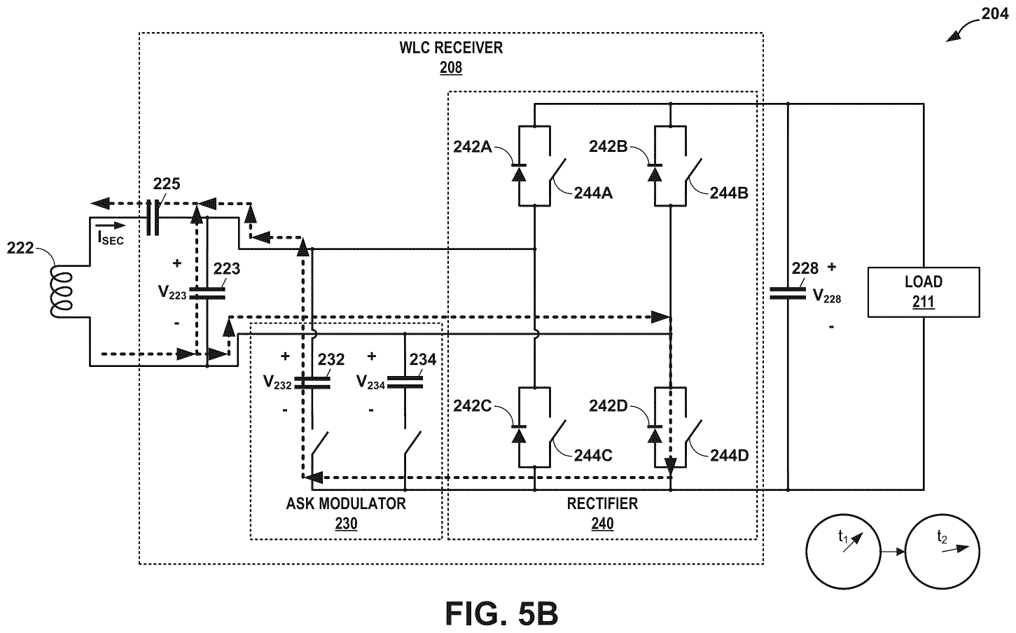

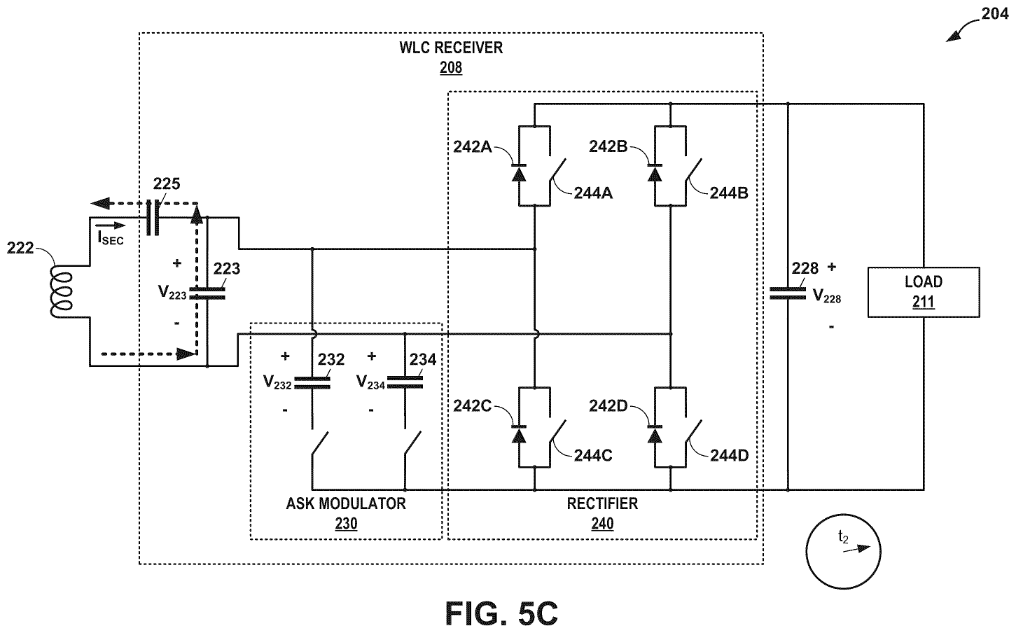

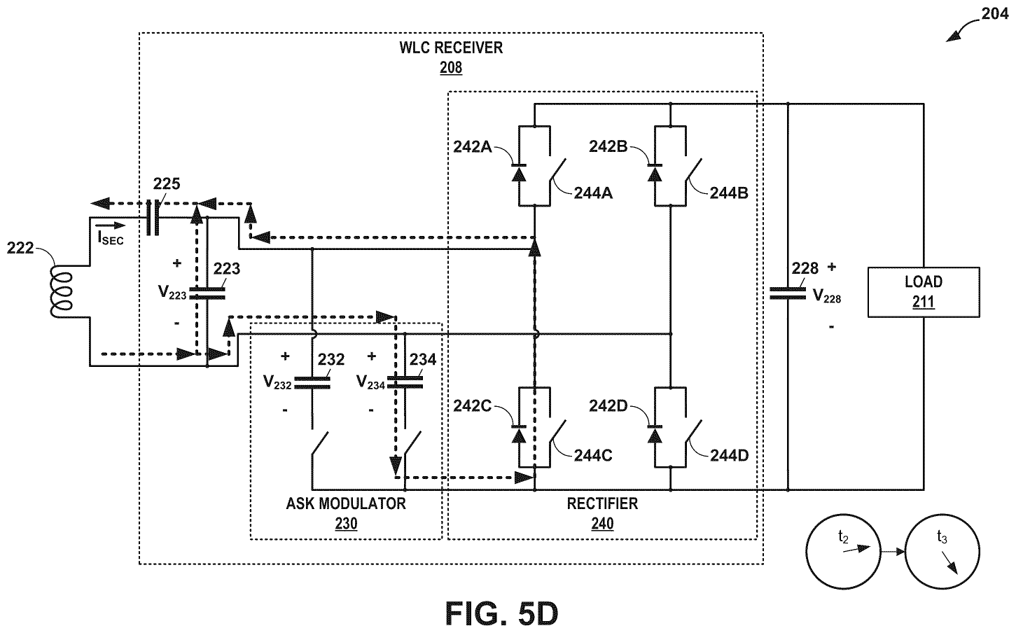

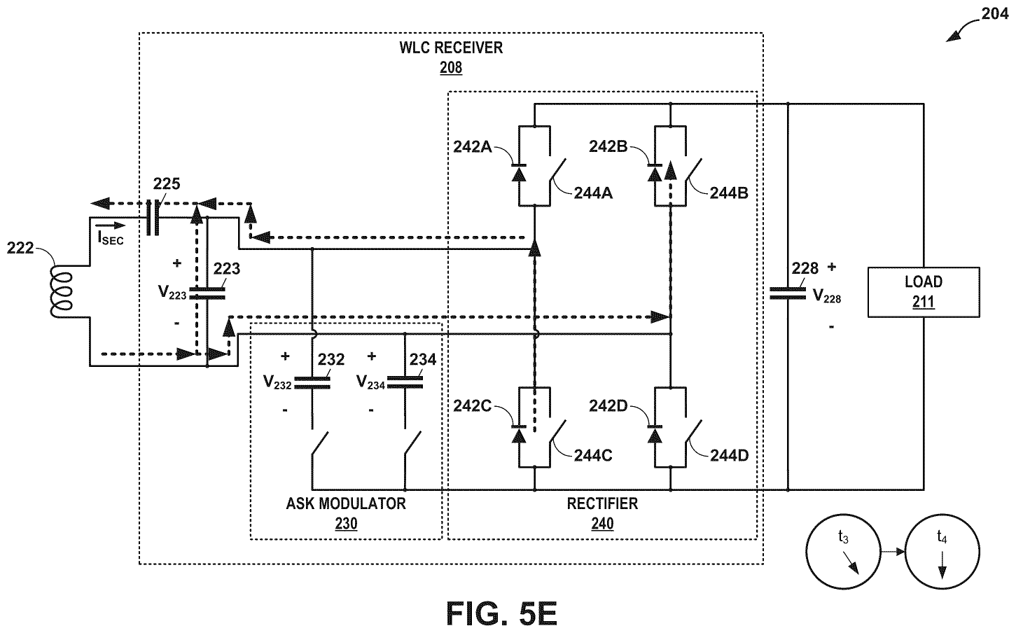

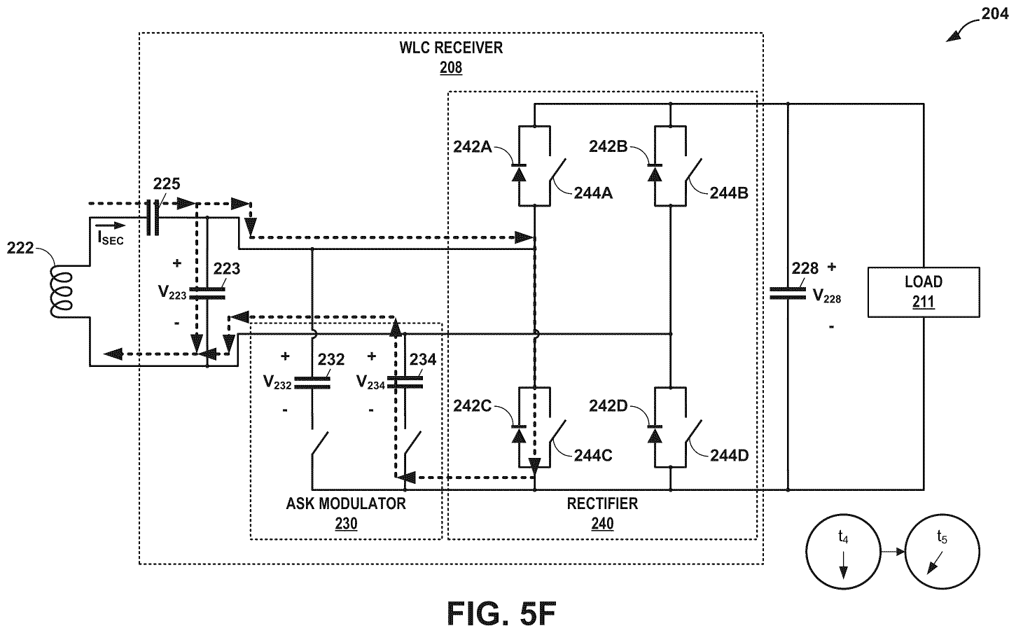

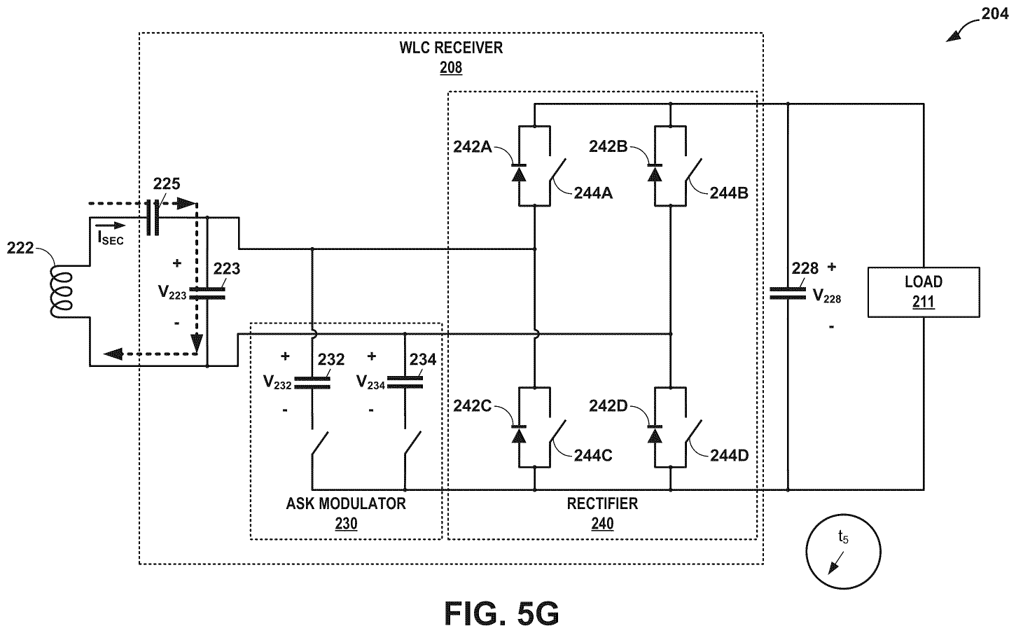

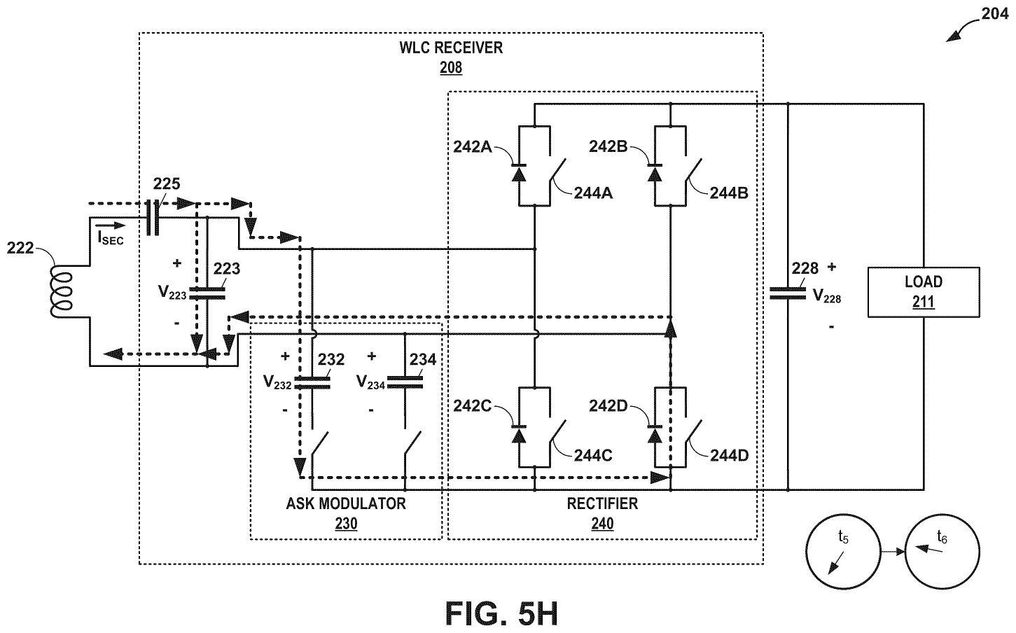

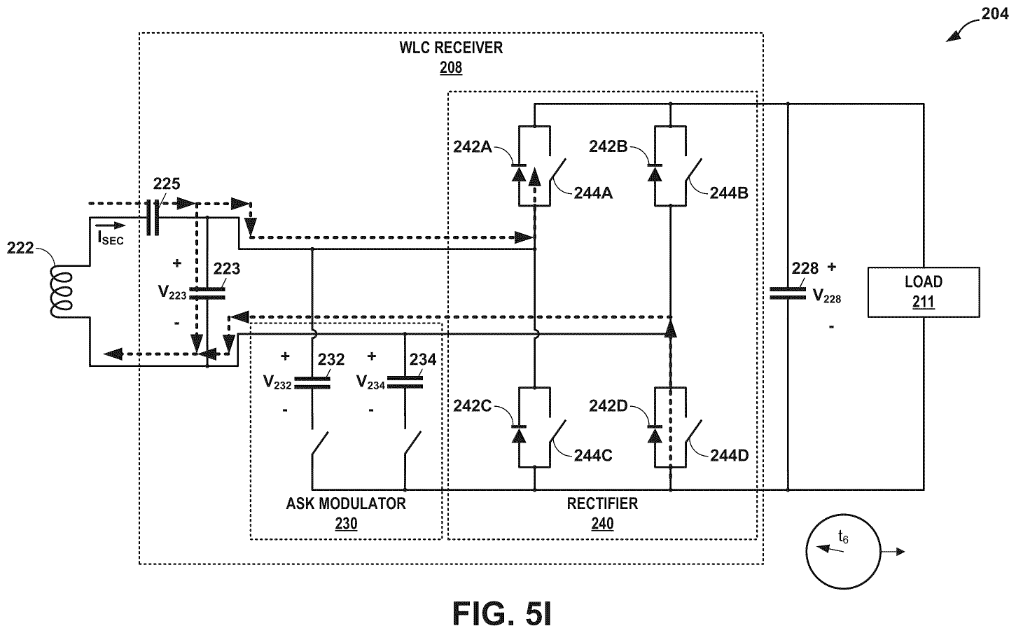

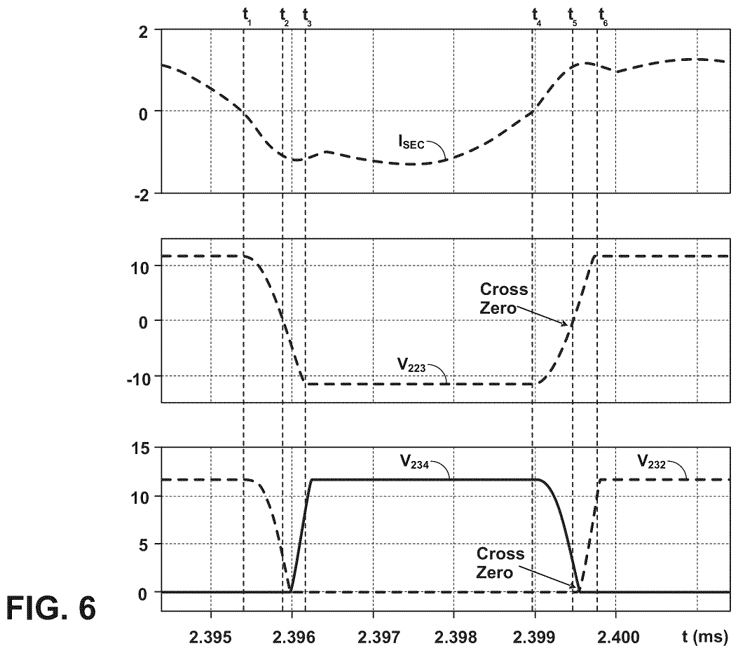

FIGS. 5A-5I are copies of the schematic of FIG. 2, with dashed lines illustrating current flows during various time periods of operation, in accordance with one or more aspects of this disclosure. FIG. 6 is a graph illustrating example voltage and current levels over the time periods described in FIGS. 5A-5I, in accordance with one or more aspects of this disclosure. The time periods shown in FIGS. 5A-5I may correspond to those shown in FIG. 6. For instance, FIG. 5A illustrates flows in a time period prior to time t₁, FIG. 5B illustrates flows in a time period between time t₁ and time t₂, FIG. 5C illustrates flows at time t₂, FIG. 5D illustrates flows in a time period between time t₂ and time t₃, FIG. 5E illustrates flows in a time period between time t₃ and time t₄, FIG. 5F illustrates flows in a time period between time t₄ and time t₅, FIG. 5G illustrates flows at time t₅, FIG. 5H illustrates flows in a time period between time t₅ and time t₆, and FIG. 5I illustrates flows in a time period after time t₆.

During t₁<t<t₃ in FIGS. 3A-3D above, all of switches 244 are off, resulting in the cascade connection of modulation capacitors 232 and 234. In accordance with one or more aspects of this disclosure, controller 226 may keep one of switches 244 to remain conductive during t₁<t<t₃. As a result, one of the modulation capacitors 232 and 234 will be bypassed and the other one will parallel with capacitor 223. This then results in an effective capacitance of capacitor 223 being increased by C_{mod} (i.e., the capacitance of each of modulation capacitors 232 and 234) during this transient. As can be seen, this increase is twice as large as the increment under scheme illustrated in FIGS. 3A-3D.

FIG. 5A starts at I_{SEC}>0, same as the starting condition in FIG. 3A. FIG. 5A illustrates flows where t<t₁. During this time period, current flows through diodes 242A and 242D may be positive (i.e., switches 244A and 244D may be closed). An input voltage across capacitor 223 (i.e., V₂₂₃) may be approximately equal to an output voltage across capacitor 228 (i.e., V₂₂₈), a voltage across modulation capacitor 232 (i.e., V₂₃₂) may be approximately equal to the output voltage across capacitor 228 (i.e., V₂₂₈), and a voltage across modulation capacitor 234 (i.e., V₂₃₄) may be approximately equal to zero.

At time t₁, the polarity of I_{SEC} may change. In the time period shown in FIG. 5B, t₁<t<t₂, controller 226 may cause switch 244D to close (e.g., regardless of the current flow not being positive). This may clamp the voltage across modulation capacitor 234 to zero and parallels modulation capacitor 232 with capacitor 223. Therefore, capacitor 223 may be equivalently increased by C_{mod} during the t₁<t<t₂ time period.

At t=t₂, V₂₂₃ and V₂₃₂ may cross zero and diode 242C may be critically forward biased, as shown in FIG. 5C. Controller 226 may cause switch 244D to open and diode 242C may naturally turn on (e.g., switches 244C may close).

As shown in FIG. 5D, t₂<t<t₃, V₂₃₂ is clamped by diode 242C at zero and modulation capacitor 234 is paralleled with capacitor 223, also adding C_{mod} to capacitor 223. Diode 242B may naturally turn on at t=t₃ as V₂₃₄=V₂₂₈. At t=t₄, a similar transient starts over. During t₄<t<t₅, controller 226 may force diode 242C on (i.e., cause switch 244C to close) and capacitor 234 to be in parallel with capacitor 223. At t=t₅, controller 226 may cease forcing diode 242C on (e.g., allow switch 244C to open), and diode 242C may turn off and diode 242D may turn on naturally. During, t₅<t<t₆, modulation capacitor 232 parallels with capacitor 223. Thus, capacitor 223 is also equivalently increased by C_{mod} in t₄<t<t₆. After t₆ the voltage and current waveforms repeat as in t<t₁.

Compared with the switching scheme described with reference to FIGS. 3A-3D, a difference in the transient waveform is that capacitors 232 and 234 are charged simultaneously under the scheme in FIGS. 3A-3D but charged separately under the scheme in FIGS. 5A-5I. Such a separate charging may achieve a doubled increment of capacitor 223. During t₁<t<t₃ and t₄<t<t₆, although one switch 244 of the rectifier is forced on, the DC bus (e.g., bus feeding load 211) does not get charged because a single switch does not provide a circuit for the charging current. So, the forced-on switch only clamps one of modulation capacitors 232 and 234, and the normal function of the rectifier is not compromised.

In some examples, the separate charging scheme of this disclosure may be implemented without hardware change. For instance, controller 226 may implement the separate charging control scheme via an adjustment to the logic used to control switches 244. As one example, controller 226 may control switches 244C and 244D to be complementary at all times. For instance, controller 226 may control switch 244C to stay on until diode 242D starts conducting. Similarly, controller 226 may control switch 244D to stay on until diode 242C starts conducting.

In some examples, controller 226 may selectively use the simultaneous charging scheme or the separate charging scheme based on situational parameters. As one example, responsive to determining that a SNR of a link between sink device 204 and a source device is low (i.e., less than a threshold), controller 226 may utilize the separate charging scheme to improve modulation depth. As another example, responsive to determining that the SNR of the link between sink device 204 and a source device is high (i.e., greater than the threshold), controller 226 may utilize the simultaneous charging scheme to improve power transfer.

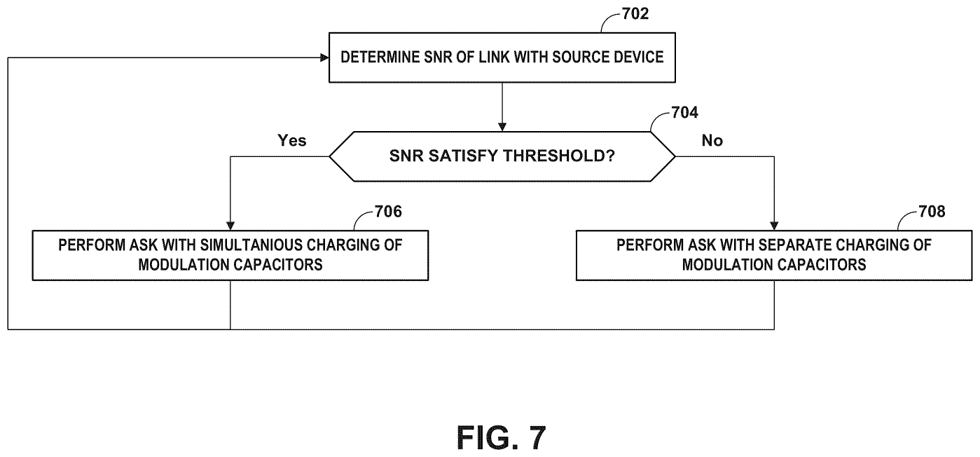

FIG. 7 is a flowchart illustrating an example technique for communicating over a wireless power link, in accordance with one or more aspects of this disclosure. The technique of FIG. 7 may be performed via a controller of a device, such as controller 226 of FIG. 2.

As noted above, controller 226 may selectively use the simultaneous charging scheme or the separate charging scheme based on situational parameters. For instance, controller 226 may determine a signal to noise ratio (SNR) of a communication link between sink device 204 and an external device (e.g., source device 102 of FIG. 1) (702). Controller 226 may determine whether or not the SNR satisfies a threshold (704). For instance, controller 226 may determine whether the SNR is greater than the threshold.

Responsive to determining that the SNR satisfies the threshold (“Yes” branch of 704), controller 226 may perform ASK communication with simultaneous charging of modulation capacitors (706). For instance, controller 226 may perform ASK modulation using the technique of FIGS. 3A-3D.

Responsive to determining that the SNR does not satisfy the threshold (“No” branch of 704), controller 226 may perform ASK communication with separate charging of modulation capacitors (708). For instance, controller 226 may perform ASK modulation using the technique of FIGS. 5A-5I.

Controller 226 may continue to monitor the SNR (702) and adjust the ASK technique between simultaneous and separate charging. In some examples, controller 226 may adjust the technique several times during a single charging session.

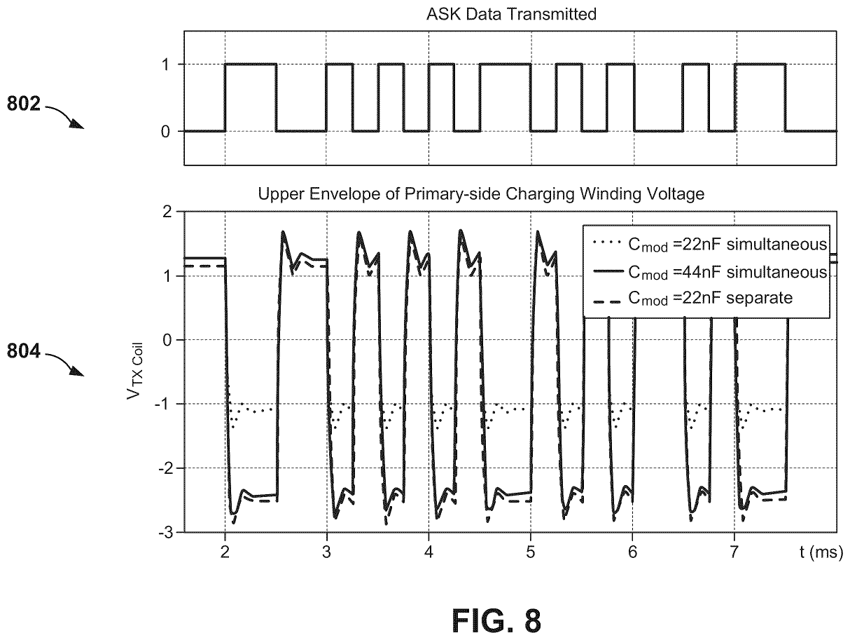

FIG. 8 is a graph illustrating example communication between a sink device and a source device, in accordance with one or more aspects of this disclosure. Graph 802 illustrates example amplitude shift keying (ASK) data transmitted and graph 804 illustrates example corresponding voltage levels at a wireless transmission coil (e.g., TX coil 118 of FIG. 1). Graph 804 shows three different received voltage signals, all corresponding to the same ASK data. As can be seen from graph 804, utilizing the separate control scheme (e.g., charging the modulation capacitors during different time periods) provides substantially improved modulation depth as compared to utilizing the simultaneous control scheme (e.g., charging the modulation capacitors at the same time). Furthermore, as can also be seen in graph 804, utilizing the separate control scheme may provide a similar modulation depth to doubling the capacitance of the modulation capacitors (e.g., but without the downsides, such as cost and size, of double said capacitance).

The following numbered examples may illustrate one or more aspects of the disclosure:

Example 1. A computing device comprising: a wireless charging receive coil that transduces, into an alternating current (AC) power signal, a magnetic field generated by a wireless charging transmit coil of an external device; an active rectifier that converts the AC signal received at an AC side of the active rectifier into a direct current (DC) power signal output at a DC side of the active rectifier, the active rectifier comprising a plurality of switches; a first modulation capacitor connected to an upper rail of the AC side; a second modulation capacitor connected to a lower rail of the AC side; and a controller configured to adjust an impedance of the computing device to communicate with the external device by at least controlling the plurality of switches to cause the first modulation capacitor and the second modulation capacitor to charge during separate time periods.

Example 2. The computing device of example 1, wherein the plurality of switches of the active rectifier includes: a first switch connecting the upper rail of the AC side to an upper rail of the DC side; a second switch connecting the lower rail of the AC side to the upper rail of the DC side; a third switch connecting the upper rail of the AC side to a lower rail of the DC side; and a fourth switch connecting the lower rail of the AC side to the lower rail of the DC side.

Example 3. The computing device of example 2, wherein, to control plurality of switches to cause the first modulation capacitor and the second modulation capacitor to charge during separate time periods, the controller is configured to: cause, during a first time period in which a current flow through the wireless charging receive coil is negative, the third switch to close; and cause, during a second time period in which the current flow through the wireless charging receive coil is positive, the fourth switch to close.

Example 4. The computing device of example 3, further comprising: an input capacitor connected across the upper rail and the lower rail of the AC side, wherein operation of the plurality of switches places the input capacitor in parallel with the first modulation capacitor during the first time period and places the input capacitor in parallel with the second modulation capacitor during the second time period.

Example 5. The computing device of example 2, wherein, to control plurality of switches to cause the first modulation capacitor and the second modulation capacitor to charge during separate time periods, the controller is configured to: operate the third switch and the fourth switch to complementary open and close.

Example 6. The computing device of example 2, wherein the controller is configured to operate the first switch and the second switch as ideal diodes.

Example 7. The computing device of example 1, wherein controlling the plurality of switches to cause the first modulation capacitor and the second modulation capacitor to charge during separate time periods comprises communicating with the external device over a communication link via a separate charging scheme, and wherein the controller is further configured to: determine one or more parameters of the communication link between the computing device and the external device; and selectively communicate, via the communication link, via the separate charging scheme or a simultaneous charging scheme.

Example 8. The computing device of example 7, wherein, to communicate via the simultaneous charging scheme, the controller is configured to cause the first modulation capacitor and the second modulation capacitor to charge in parallel.

Example 9. The computing device of example 7, wherein the one or more parameters comprise a signal-to-noise ratio (SNR) of the communication link.

Example 10. A method comprising: transducing, by a wireless charging receive coil of an electronic device, into an alternating current (AC) power signal, a magnetic field generated by a wireless charging transmit coil of an external device; converting, by an active rectifier of the electronic device, the AC signal received at an AC side of the active rectifier into a direct current (DC) power signal output at a DC side of the active rectifier, the active rectifier comprising a plurality of switches; and communicating, by a controller of the electronic device, with an external device by at least adjusting an impedance of the electronic device including controlling the plurality of switches to cause a first modulation capacitor and a second modulation capacitor to charge during separate time periods, the first modulation capacitor connected to an upper rail of the AC side and the second modulation capacitor connected to a lower rail of the AC side.

Example 11. A computer-readable storage medium storing instructions that, when executed by a controller of an electronic device, cause the controller to: control switches of an active rectifier of the electronic device to communicate with an external device by at least causing a first modulation capacitor and a second modulation capacitor to charge during separate time periods, the first modulation capacitor connected to an upper rail of an AC side of the active rectifier and the second modulation capacitor connected to a lower rail of the AC side.

Example 12. Any combination of examples 1-11.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computing device comprising:
a wireless charging receive coil that transduces, into an alternating current (AC) power signal, a magnetic field generated by a wireless charging transmit coil of an external device;
an active rectifier that converts the AC signal received at an AC side of the active rectifier into a direct current (DC) power signal output at a DC side of the active rectifier, the active rectifier comprising a plurality of switches;
a first modulation capacitor connected to an upper rail of the AC side;
a second modulation capacitor connected to a lower rail of the AC side; and
a controller configured to adjust an impedance of the computing device to communicate with the external device by at least controlling the plurality of switches to cause the first modulation capacitor and the second modulation capacitor to charge during separate time periods.

2. The computing device of claim 1, wherein the plurality of switches of the active rectifier includes:
a first switch connecting the upper rail of the AC side to an upper rail of the DC side;
a second switch connecting the lower rail of the AC side to the upper rail of the DC side;
a third switch connecting the upper rail of the AC side to a lower rail of the DC side; and
a fourth switch connecting the lower rail of the AC side to the lower rail of the DC side.

3. The computing device of claim 2, wherein, to control the plurality of switches to cause the first modulation capacitor and the second modulation capacitor to charge during separate time periods, the controller is configured to:
cause, during a first time period in which a current flow through the wireless charging receive coil is negative, the third switch to close; and
cause, during a second time period in which the current flow through the wireless charging receive coil is positive, the fourth switch to close.

4. The computing device of claim 3, further comprising:
an input capacitor connected across the upper rail and the lower rail of the AC side, wherein operation of the plurality of switches places the input capacitor in parallel with the first modulation capacitor during the first time period and places the input capacitor in parallel with the second modulation capacitor during the second time period.

5. The computing device of claim 2, wherein, to control the plurality of switches to cause the first modulation capacitor and the second modulation capacitor to charge during separate time periods, the controller is configured to:
operate the third switch and the fourth switch to complementary open and close.

6. The computing device of claim 2, wherein the controller is configured to operate the first switch and the second switch as ideal diodes.

7. The computing device of claim 1, wherein, to control the plurality of switches to cause the first modulation capacitor and the second modulation capacitor to charge during separate time periods, the controller is configured to communicate with the external device over a communication link via a separate charging scheme, and wherein the controller is further configured to:
determine one or more parameters of the communication link between the computing device and the external device; and
selectively communicate, via the communication link, via the separate charging scheme or a simultaneous charging scheme.

8. The computing device of claim 7, wherein, to communicate via the simultaneous charging scheme, the controller is configured to cause the first modulation capacitor and the second modulation capacitor to charge in parallel.

9. The computing device of claim 7, wherein the one or more parameters comprise a signal-to-noise ratio (SNR) of the communication link.

10. A method comprising:
transducing, by a wireless charging receive coil of an electronic device, into an alternating current (AC) power signal, a magnetic field generated by a wireless charging transmit coil of an external device;
converting, by an active rectifier of the electronic device, the AC signal received at an AC side of the active rectifier into a direct current (DC) power signal output at a DC side of the active rectifier, the active rectifier comprising a plurality of switches; and
communicating, by a controller of the electronic device, with an external device by at least adjusting an impedance of the electronic device including controlling the plurality of switches to cause a first modulation capacitor and a second modulation capacitor to charge during separate time periods, the first modulation capacitor connected to an upper rail of the AC side and the second modulation capacitor connected to a lower rail of the AC side.

11. The method of claim 10, wherein the plurality of switches of the active rectifier includes:
a first switch connecting the upper rail of the AC side to an upper rail of the DC side;
a second switch connecting the lower rail of the AC side to the upper rail of the DC side;
a third switch connecting the upper rail of the AC side to a lower rail of the DC side; and
a fourth switch connecting the lower rail of the AC side to the lower rail of the DC side.

12. The method of claim 11, wherein controlling the plurality of switches to cause the first modulation capacitor and the second modulation capacitor to charge during separate time periods comprises:
causing, during a first time period in which a current flow through the wireless charging receive coil is negative, the third switch to close; and
causing, during a second time period in which the current flow through the wireless charging receive coil is positive, the fourth switch to close.

13. The method of claim 12, wherein the electronic device comprises an input capacitor connected across the upper rail and the lower rail of the AC side, wherein controlling the plurality of switches comprises placing the input capacitor in parallel with the first modulation capacitor during the first time period and placing the input capacitor in parallel with the second modulation capacitor during the second time period.

14. The method of claim 11, wherein controlling the plurality of switches to cause the first modulation capacitor and the second modulation capacitor to charge during separate time periods comprises operating the third switch and the fourth switch to complementary open and close.

15. The method of claim 10, wherein controlling the plurality of switches to cause the first modulation capacitor and the second modulation capacitor to charge during separate time periods comprises communicating with the external device over a communication link via a separate charging scheme, and wherein the method further comprises:
determining one or more parameters of the communication link between the electronic device and the external device; and
selectively communicating, via the communication link, via the separate charging scheme or a simultaneous charging scheme.

16. The method of claim 15, wherein communicating via the simultaneous charging scheme, comprises causing the first modulation capacitor and the second modulation capacitor to charge in parallel.

17. A computer-readable storage medium storing instructions that, when executed by a controller of an electronic device, cause the controller to:
control switches of an active rectifier of the electronic device to communicate with an external device by at least causing a first modulation capacitor and a second modulation capacitor to charge during separate time periods, the first modulation capacitor connected to an upper rail of an alternating current (AC) side of the active rectifier and the second modulation capacitor connected to a lower rail of the AC side.

18. The computer-readable storage medium of claim 17, wherein the plurality of switches of the active rectifier includes:
a first switch connecting the upper rail of the AC side to an upper rail of a direct current (DC) side of the active rectifier;
a second switch connecting the lower rail of the AC side to the upper rail of the DC side;
a third switch connecting the upper rail of the AC side to a lower rail of the DC side; and
a fourth switch connecting the lower rail of the AC side to the lower rail of the DC side.

19. The computer-readable storage medium of claim 18, wherein the instructions that cause the controller to control the plurality of switches to cause the first modulation capacitor and the second modulation capacitor to charge during separate time periods comprise instructions that cause the controller to:
cause, during a first time period in which a current flow through a wireless charging receive coil of the electronic device is negative, the third switch to close; and
cause, during a second time period in which the current flow through the wireless charging receive coil is positive, the fourth switch to close.

20. The computer-readable storage medium of claim 18, wherein the instructions that cause the controller to control the plurality of switches to cause the first modulation capacitor and the second modulation capacitor to charge during separate time periods comprise instructions that cause the controller to:
operate the third switch and the fourth switch to complementary open and close.
